(19) United States
(12) Patent Application Publication
(10) Pub. No.: US 2009/0026913 A1
(43) Pub. Date: Jan. 29, 2009

(54) Dynamic color or white light phosphor converted LED illumination system

(76) Inventor: Matthew Steven Mrakovich, Streetsboro, OH (US)

Correspondence Address: FAY SHARPE LLP, 1100 SUPERIOR AVENUE, SEVENTH FLOOR, CLEVELAND, OH, 44114, US

(21) Appl. No.: 11/828,641

(22) Filed: Jul. 26, 2007

(51) Int. Cl. H01J 61/00; G09G 3/32

(52) U.S. Cl. 313/498; 315/169.3

(57) ABSTRACT

A color tunable light emitting device includes multiple light emitting components such as light emitting diodes (LEDs) or laser diodes (LDs) with substantially the same emission characteristics, and multiple phosphors materials with different excitation and emission wavelengths, each excited by one of the light emitting components. The light emitting components are powered by an electrical circuit which allows separate control of the optical power output of the different light emitting components. The light from the light emitting components is arranged to impinge and excite a corresponding phosphor material such that the phosphors are excited and emit light at their characteristic wavelengths. By separately adjusting the power to each LED/LD, the amount of light emitted by each phosphor, and hence, through color mixing, the color of the light emitted, is varied.

### BACKGROUND

This invention relates to the illumination arts. More particularly, this invention relates to a color-tunable lighting system incorporating a plurality of phosphors and light emitting diodes (LEDs) or laser diodes (LDs) which is capable of producing visible white or colored light of different wavelengths.

Light emitting diodes and lasers have been produced from Group III-V alloys, such as gallium nitride (GaN)-based LEDs. To form the LEDs, layers of the GaN-based alloys are typically deposited epitaxially on a substrate, such as a silicon carbide or sapphire substrate, and may be doped with a variety of n and p-type dopants to improve properties, such as light emission efficiency. Such GaN-based LEDs generally emit light in the UV and/or blue range of the electromagnetic spectrum.

Recently, techniques have been developed for converting the light emitted from LEDs to useful light for illumination purposes. In one technique, the LED is coated or covered with a phosphor layer. A phosphor is a luminescent material that absorbs radiation energy in a portion of the electromagnetic spectrum and emits energy in another portion of the electromagnetic spectrum. Phosphors of one important class are crystalline inorganic compounds of very high chemical purity and of controlled composition to which small quantities of other elements (called “activators”) have been added to convert them into efficient fluorescent materials. With the right combination of activators and inorganic compounds, the color of the emission can be controlled. Most useful and well-known phosphors emit radiation in the visible portion of the electromagnetic spectrum in response to excitation by electromagnetic radiation outside the visible range.

By interposing a phosphor excited by the radiation generated by the LED, light of a different wavelength, e.g., in the visible range of the spectrum, may be generated. Colored LEDs are often used in toys, indicator lights and other devices. Continuous performance improvements have enabled new applications for LEDs of saturated colors in traffic lights, exit signs, store signs, and the like.

In addition to colored LEDs, a combination of LED generated light and phosphor generated light may be used to produce white light. The most popular white LEDs consist of blue emitting GaInN chips. The blue emitting chips are coated with a phosphor that converts some of the blue radiation to a complementary color, e.g. a yellowish emission. Together, the blue and yellowish radiation produces a white light. There are also white LEDs that utilize a near UV emitting chip and a phosphor blend including red, green and blue-emitting phosphors designed to convert the UV radiation to visible light.

Known white light emitting devices comprise a blue light-emitting LED having a peak emission wavelength in the near blue range (from about 440 nm to about 480 nm) combined with a yellow light-emitting phosphor, such as cerium(III) doped yttrium aluminum garnet (“YAG:Ce”), a cerium(III) doped terbium aluminum garnet (“TAG:Ce”), or a europium(II) doped barium orthosilicate (“BOS”). The phosphor absorbs a portion of the radiation emitted from the LED and converts the absorbed radiation to a yellow light. The remainder of the blue light emitted by the LED is transmitted through the phosphor and is mixed with the yellow light emitted by the phosphor. A viewer perceives the mixture of blue and yellow light as a white light. The total of the light from the phosphor material and the LED chip provides a color point with corresponding color coordinates (x and y) and correlated color temperature (CCT), and its spectral distribution provides a color rendering capability, measured by the color rendering index (CRI).

The wavelength of the light emitted by the phosphor is dependent on the particular phosphor material used. For example, a blue absorbing, yellow emitting phosphor, such as YAG, can be used to generate yellow light. Light sources produced in this manner are suited to a wide variety of applications, including lamps, displays, back light sources, traffic signals, illuminating switches, and the like.

In some cases, it is desirable to change the color of light. For example, certain light tones are suited for working, yet are considered too harsh for other activities. At present, this need is satisfied with discharge-based fluorescent lights by changing the relative proportions of phosphors in the phosphor coatings in order to attain a specified color coordinate. Thus, the light source is set at the factory to emit light of a particular wavelength or wavelengths and could not be adjusted by the consumer to emit light of a different tone. To change color temperature, the light source could be replaced by one of a different tone. This is time consuming and not practical for changing the tone at frequent intervals. Alternatively, one light could be switched off and another switched on. This option is not practical for most purposes, since multiple lights and electrical connections are required.

Alternately, a dynamic color LED system can be used. Current dynamic color LED systems such as RGB systems require sophisticated electronics to compensate for the performance difference between the different LED material systems such as InGaN for Blue and Green and AlInGaP for Red. Because these different LED material systems behave very differently with respect to time, temperature, and drive current, complicated circuitry, sensors, pre-programed logic, and feedback loops are required to provide consistent performance. In addition to the complicated circuitry, the typical RGB system does not provide a broad spectrum of light. This lack in spectrum of the typical RGB system will not provide a high quality of light that renders all colors very well. The typical Dynamic color LED systems uses red, green, and blue LEDs where each LED color is controlled separately to enable the dynamic color changing. Some systems have added other colors such as orange, yellow or amber, or white to broaden the spectrum but the additional colors further complicate the circuitry and electronics.

With regard to white light devices, the total of the light from the phosphor material and the LED chip provides a fixed color point with corresponding color coordinates (x and y) and correlated color temperature (CCT), and its spectral distribution provides a color rendering capability, measured by the color rendering index (CRI).

Such systems can be used to makes devices having CCTs of >4500 K and CRIs ranging from about 70-82, with luminous efficacy of radiation (“LER”, also referred to as luminosity) of about 330 Im/Wₒₚₜ. While this range is suitable for many applications, general illumination sources usually require lower CCTs and higher CRIs, preferably with similar or better LER. As the CCT is lowered and/or the CRI is increased, the LER value generally decreases, leading to values for “warm white” LEDs (of CCT<4500 K) significantly lower than those for “cool white” LEDs (of CCT>4500 K). To change the properties of a white light as desired, one must replace the device with a new one.

Thus, it would be desirable to provide devices having the ability to dynamically change the emitted color in the case of colored devices, or the characteristics of the light in white light devices. The present invention provides a new and improved color tunable or white light source and method of use, which overcomes the above-referenced problems and others.

### BRIEF SUMMARY

In a first aspect, there is provided a light emitting device including at least first and second semiconductor radiation emitters, which emit radiation having a first peak wavelength, a first phosphor material radiationally coupled with said first semiconductor radiation emitter, the first phosphor material capable of absorbing at least a part of the radiation from the first radiation emitter and emitting light of a second wavelength, and a second phosphor material radiationally coupled to said second semiconductor radiation emitter, which is capable of absorbing at least a part of the radiation from the second radiation emitter and emitting light of a third wavelength, wherein the first phosphor is at least substantially isolated from the second radiation emitter and the second phosphor is at least substantially isolated from the first radiation emitter.

In another exemplary embodiment of the present invention, a method of changing the color of light is provided. The method includes providing at least first and second semiconductor radiation emitters, which emit radiation having a first peak wavelength, a first phosphor material radiationally coupled with said first semiconductor radiation emitter, the first phosphor material capable of absorbing at least a part of the radiation from the first radiation emitter and emitting light of a second wavelength, and a second phosphor material radiationally coupled to said second semiconductor radiation emitter, which is capable of absorbing a part of the radiation from the second radiation emitter and emitting light of a third wavelength, wherein the first phosphor is at least substantially isolated from the second radiation emitter and the second phosphor is at least substantially isolated from the first radiation emitter. The method may include adjusting power supplied to at least one of the first and second light emitters separately from the other of the first and second light emitters such that the amount of light emitted by the at least one the first and second light emitters is adjusted. Further, the method includes combining the light emitted by the first phosphor and the second phosphor materials.

### BRIEF DESCRIPTION OF THE DRAWINGS

FIG. 1 is a side sectional view of a light emitting device according to the present invention.

FIG. 2 is an emission intensity spectrum for three phosphors, A, B, and C, according to the present invention.

FIG. 3 is another embodiment of a light emitting device according to the present invention.

FIG. 4 is an electrical circuit diagram of a control system for a two sub-array light emitting device, according to the present invention.

FIG. 5 is a schematic diagram of a control system for a light emitting device having three sub-arrays, according to an alternative embodiment of the present invention.

### DESCRIPTION OF THE PREFERRED EMBODIMENTS

The present embodiments relate to a broad spectrum dynamic color or white phosphor converted LED illumination system. In one embodiment, an array of LEDs having the same spectral emission properties are each coupled with single or multiple component phosphors that are excited by at least one of the LEDs in the array. The system is preferably designed such that it contains multiple sub arrays isolated from each other, wherein each sub array comprises at least one LED chip and a phosphor material having a different emission color. The resultant overall color of the device can then be easily changed by varying the current to the LED chip or chips in a sub array, thus changing the amount a given phosphor material is excited.

The color of the visible light generated by the device is dependent on the identity and amounts of the particular components of the phosphor materials used as well as the amount of current supplied to any of the given sub arrays. The phosphor material in each sub array may include only a single phosphor composition or two or more phosphors of basic color, for example a particular mix with one or more of a green, blue and red phosphor to emit a desired color (tint) of light. As used herein, the terms “phosphor material” and “luminescent material” are used interchangeably and may be used to denote both a single phosphor composition as well as a blend of two or more phosphors. As used herein, the term “sub array” is used to denote one or more chips and a radiationally coupled phosphor material. “Radiationally coupled” means that the one or more chips and the phosphor material are associated with each other so that at least part of the radiation emitted from one is transmitted to the other. “Substantially isolated” means that no more than 5% of the radiation emitted by a first structure is transmitted to a second structure. Preferably, less than 1% of the radiation is transmitted and even more preferably, 0% of the radiation is transmitted.

Preferably, semiconductor light sources such as an LED chips are used in the plurality of sub arrays, with a peak emission may range from, e.g., 200-500 nm. In one preferred embodiment, however, the emission of the LED will be in the near UV to violet region and have a peak wavelength in the range from about 300 to about 420 nm, more preferably from about 370 to 410 nm. An exemplary LED having a peak emission at about 405 nm is especially preferred. Preferably, all the LEDs in the device will have the same or substantially the same peak emission. This uniformity allows a manufacturer to do away with complicated control systems that would be necessary if LEDs of different emission wavelengths were used due to the characteristics differences of such disparate LEDs with respect to time, temperature, drive current, etc. Typically, the semiconductor light source comprises an LED doped with various impurities. Thus, the LED may comprise a semiconductor diode based on any suitable III-V, II-VI or IV-IV semiconductor layers.

Preferably, the LED may contain at least one semiconductor layer comprising GaN, AIN or SiC. For example, the LED may comprise a nitride compound semiconductor represented by the formula InᵢGaⱼAlₖN (where 0≦i; 0≦j; 0≦k and i+j+k=1) having a peak emission wavelength greater than about 200 nm and less than about 500 nm. Such LED semiconductors are known in the art. The radiation source is described herein as an LED for convenience. However, as used herein, the terms “LED” and “LED chip” are meant to encompass all semiconductor radiation sources including, e.g., semiconductor laser diodes. The LEDs can be packaged LEDs or chips on a printed circuit board (“PCB”), as is known in the art.

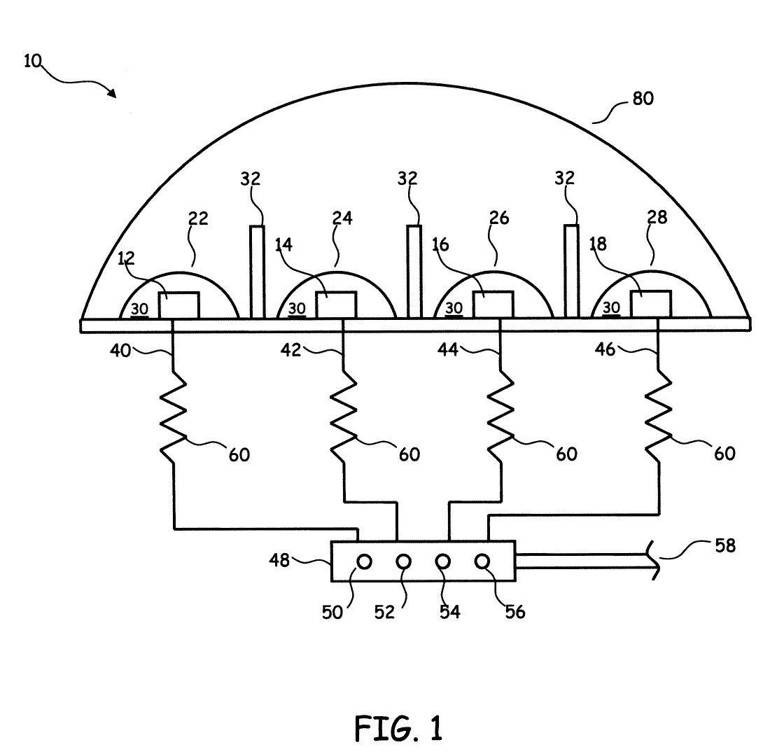

Thus, with reference to FIG. 1, a light source, such as a lamp 10 includes a bank of multiple semiconductor light sources 12, 14, 16, 18, such as light emitting diodes LEDs or laser diodes LDs, is positioned on a PCB or other support 20. FIG. 1, shows four LEDs/LDs positioned on the same support for exemplary purposes, however, the number may vary from two or greater. Likewise, each LED can be positioned on its own separate support as well.

Light is emitted by the light sources 12, 14, 16, 18 impinges on different phosphor materials 22, 24, 26, 28 associated with each individual light source, which convert all or a portion of the emitted light from the light sources to longer wavelengths, preferably in the visible range. Although FIG. 1 shows a single LED associated with each phosphor material, there can be any number of LEDs associated with each phosphor material. Each LED/associated phosphor material may be thought of as a sub-array. As noted, there can be more than one LED in each subarray.

The phosphor materials are coated or otherwise supported on transparent shells or other substrates, which can take any geometry and are shown in FIG. 1 as being hemispherical in shape. Of course other shapes are also possible. The phosphor materials are preferably spaced apart from the light sources, such that a gap 30 exists between the light sources and the phosphor coated substrates. This gap can be an air gap or filled with some type of gas or other encapsulant material. The shell or substrate material on or in which the phosphor materials are contained may be, for example, glass or plastic.

The phosphor material layers in the above embodiments are deposited by any appropriate method. For example, a water based suspension of the phosphor(s) can be formed, and applied as a phosphor layer to the shell surface. When present, both the shell and the encapsulant should preferably be substantially transparent to allow radiation from the phosphor layers and, in certain embodiments, the LED chip, to be transmitted therethrough. Although not intended to be limiting, in one embodiment, the median particle size of the phosphor particles in the phosphor materials may be from about 1 to about 10 microns.

In one embodiment, the gaps 30 between the light sources and the shell or substrate is preferably an epoxy, silicone, plastic, low temperature glass, polymer, thermoplastic, thermoset material, resin or other type of LED encapsulating material as is known in the art. Optionally, the encapsulant is a spin-on glass or some other high index of refraction material. Preferably, the encapsulant material is an epoxy and/or a polymer material, such as silicone or silicone copolymer or blend.

Baffles 32 that absorb or reflect radiation emitted by the light sources are preferably positioned between each LED/phosphor material sub-array such that radiation emitted by each phosphor material absorbs radiation only from its associated LED and is substantially isolated from the other LEDs in the other sub-arrays. Optionally, a light transmissive plate 34 covers the entire assembly. The plate may be a lens or other optics, for focusing, mixing or modify light emitted by the phosphor materials, or a sheet of light transmissive material, such as glass, plastic, or the like.

The phosphor materials are substances which are capable of absorbing a part of the light emitted by the LEDs and emitting light of a wavelength different from that of the absorbed light. When used in a system with LEDs having the same emission characteristics, the phosphor materials preferably will be chosen such that each can be excitable by the emission of the LEDs, i.e. have an excitation sensitivity in the wavelength range of the emitted radiation from the LEDs.

The phosphor materials in each sub-array will have different emission characteristics. In one embodiment, discussed below, each phosphor material will have an emission at a different wavelength. In another embodiment, the phosphor materials will be white light producing phosphor blends having different CCT values. By varying the emission intensity of the LEDs in each sub-array independently, the emission from one or more of the phosphor materials can be used to create different colored light from the device, including white light. That is, the light from an individual phosphor material (and possibly the LEDs), either alone or in combination with the light from one or more other phosphor materials in the device, can be used to create an output light of various colors, as desired by a user. In one embodiment, the transmissive plate may comprise a lens or other light mixing optical elements such that the light emitted from the phosphor materials is combined to form a mixture of the various emitted wavelengths. Obviously, a variety of combinations of light emitting components and phosphors having different emission and excitation wavelengths can be used to achieve a variety of color ranges.

With reference once more to FIG. 1, in one embodiment, each of the LEDs 12, 14, 16, 18 is separately controllable by adjusting the power supplied to each of the LEDs. Each LED has a separate electrical circuit 40, 42, 44, 46, respectively. Where more than one LED is used in each sub-array, these may be powered together as a bank or separately. The amount of light emitted by an LED increases as the current flowing through the circuit is increased. This allows the emission of the LED (or LEDs) in each sub-array to be separately controlled. As shown in FIG. 1, a controller 48 has controls 50, 52, 54, and 56 for separately controlling the power supplied to each of the light emitting components circuits 40, 42, 44, 46, from an external source of power, such as a mains power supply 58. The controls may be infinitely variable, for example by employing a rheostat 60 in each circuit, or may be adjustable step-wise, such that the operator has a choice of two or more settings for each LED. As well as controlling the color of the emitted light, the intensity of the emitted light may also be varied by adjusting the total power supplied to the bank of LEDs.

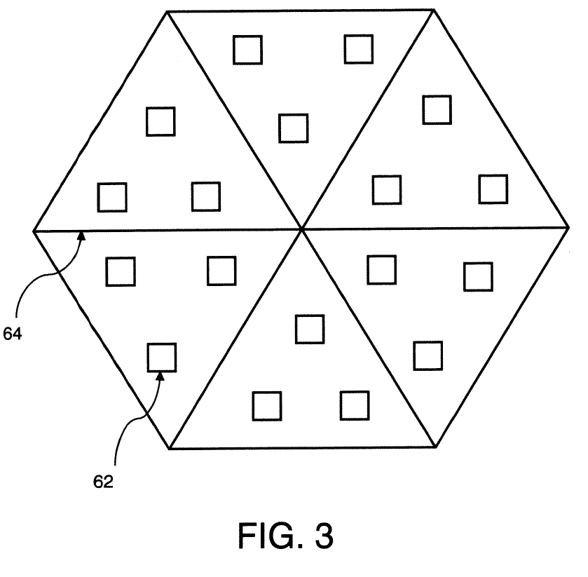

An alternate arrangement for an LED array according to another embodiment is shown in FIG. 3. In this arrangement, sub-arrays of LED chips 62 covered with different phosphor materials emitting at different wavelengths are separated by baffles 64 to eliminate cross-talk between the sub-arrays. By varying the amount of power received by the LEDs in each of the sub-arrays, the device can be made to emit different colors.

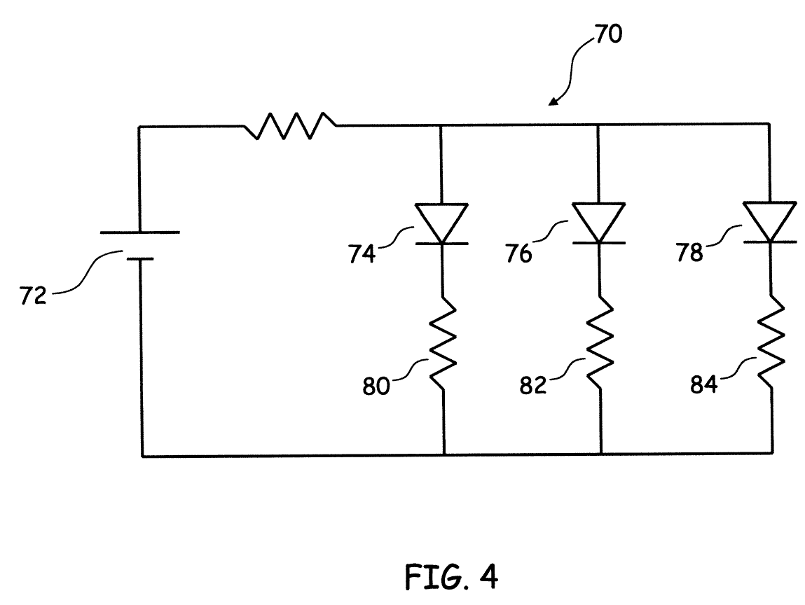

An electrical circuit 70 for a light device having three sub-arrays, with one LED in each sub-array in FIG. 4. A power source 72 is connected in parallel with the LEDs 74, 76, 78. Rheostat controls 80, 82, 84 control the amount of power received by each of the two LDs/LEDs.

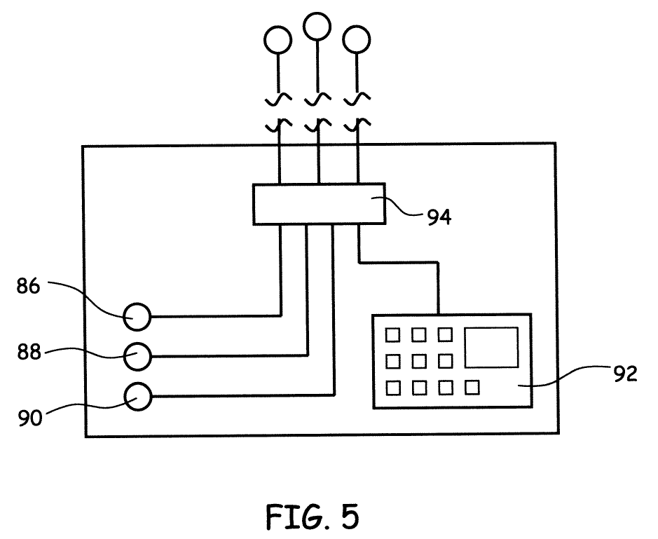

A variety of other control systems are also contemplated. For example, as shown in FIG. 5, the operator selects a color of light by pressing a switch 86, 88, or 90, corresponding to a preselected light color or by entering a number on a keypad 92, or using some other switching element. A control system 94 accesses a look up table which shows how much power should be supplied to each LED or sub-array 96, 98, 100 to provide the color selected. The control system then adjusts the power supplied to each LED or sub-array accordingly. For example, switch 86 may correspond to light which approximates white light, but has a slightly blue tone suited for work environments, while switches 88, and 90 may correspond to light of a slightly yellow or red hue, respectively. The keypad 92 provides finer adjustments of the color. For, example, by selecting a number from 1 to 100, the operator selects one of a hundred incrementally changing light colors. Three buttons and LEDs are shown here for ease of illustration, although of course more or less are possible.

### Phosphors

Although not intended to be limiting, particularly preferred phosphors for use in the phosphor materials of the present embodiments include garnets activated with at least Ce³⁺ (e.g. YAG:Ce, TAG:Ce and their compositional modifications known in the art), and alkaline earth orthosilicates activated with at least Eu²⁺, e.g. (Ba,Sr,Ca)₂SiO₄:Eu²⁺ (“BOS”) and its compositional modifications known in the art. Other particularly preferred phosphors are sulfides activated with at least Eu²⁺ , e.g. (Sr,Ca)S:Eu²⁺ , and M—Si—N nitrides, M—Al—Si—N nitrides, M—Si—O—N oxynitrides or M—Si—Al—O—N sialons activated with at least Eu²⁺ (e.g. where M is an alkali or alkaline earth metal) also known in the art.

It is contemplated that various phosphors which are described in this application in which different elements enclosed in parentheses and separated by commas, such as (Sr,Ca)S:Eu²⁺ can include any or all of those specified elements in the formulation in any ratio. For example, the phosphor identified above has the same meaning as (SrₐCa₁₋ₐS):Eu²⁺, where a may assume values from 0 to 1, including the values of 0 and 1.

Examples of other phosphors which may be utilized include:
BaMg₂Al₁₆O₂₇:Eu²⁺ —a blue emitter
Ca₈Mg(SiO₄)₄Cl₂:Eu²⁺ ,Mn²⁺ —a green emitter
Y₂₀O₃:Bi³⁺,Eu²⁺—a red emitter

Still other phosphors which may be utilized, in a wide range of combinations, include cerium activated phosphors of garnet-based fluorophors containing at least one element selected from the group consisting of Y, Lu, Sc, La, Gd, and Sm and at least one element selected from Al, Ga, and In. Examples of this type of phosphor include Y₃Al₅O₁₂:Ce. Other suitable phosphors include Y₂0₂S:Eu (a red emitter); and ZnS:Cu,Ag (a green emitter).

Other phosphors in addition to or in place of the above phosphors may be used. One such suitable phosphor is A₂₋₂ₓNa₁₊EₓD₂V₃O₁₂, wherein A may be Ca, Ba, Sr, or combinations of these; E may be Eu, Dy, Sm, Tm, or Er, or combinations thereof; D may be Mg or Zn, or combinations thereof and x ranges from 0.01 to 0.3. In addition, other suitable phosphors for use in the phosphor materials include:
(Ba,Sr,Ca)₅(PO₄)₃(Cl,F,Br,OH):Eu²⁺,Mn²⁺
(Ba,Sr,Ca)BPO₅:Eu²⁺,Mn²⁺
(Sr,Ca)₁₀(PO₄)₆*vB₂O₃:Eu²⁺ (wherein 0<v≦1)
Sr₂Si₃O₈*2SrCl₂:Eu²⁺
(Ca,Sr,Ba)₃MgSi₂O₈:Eu²⁺,Mn²⁺
BaAl₈O₁₃:Eu²⁺
2SrO*0.84P₂O₅*0.16B₂O₃:Eu²⁺
(Ba,Sr,Ca)MgAl₁₀O₁₇:Eu²⁺,Mn²⁺
(Ba,Sr,Ca)Al₂O₄:Eu²⁺
(Y,Gd,Lu,Sc,La)BO₃:Ce³⁺,Tb³⁺
(Ba,Sr,Ca)₂Si_{1-ξ}O_{4-2ξ}:Eu²⁺ (wherein 0≦ξ≦0.2)
(Ba,Sr,Ca)₂(Mg,Zn)Si₂O₇:Eu²⁺
(Sr,Ca,Ba)(Al,Ga,In)₂S₄:Eu²⁺
(Y,Gd,Tb,La,Sm,Pr,Lu)₃(Sc,Al,Ga)_{5-α}O_{12-3/2α}:Ce³⁺ (wherein 0≦α≦0.5)
(Lu,Sc,Y,Tb)₂₋ᵤ₋ᵥCeᵥCa₁₊ᵤLi_{w}Mg_{2-w}P_{w}(Si,Ge)_{3-w}O_{12-u/2}where −0.5≦u≦1; 0<v≦0.1; and 0≦w≦0.2
(Ca,Sr)₈(Mg,Zn)(SiO₄)₄Cl₂:Eu²⁺,Mn²⁺
Na₂Gd₂B₂O₇:Ce³⁺,Tb³⁺
(Sr,Ca,Ba,Mg,Zn)₂P₂O₇:Eu²⁺,Mn²⁺
(Gd,Y,Lu,La)₂O₃:Eu³⁺,Bi³⁺
(Gd,Y,Lu,La)₂O₂S:Eu³⁺,Bi³⁺
(Gd,Y,Lu,La)VO₄:Eu³⁺, Bi³⁺
(Ca,Sr)S:Eu²⁺,Ce³⁺
ZnS:Cu⁺,Cl⁻
ZnS:Cu⁺,Al³⁺
ZnS:Ag⁺,Cl⁻
ZnS:Ag⁺,Al³⁺
SrY₂S₄:Eu²⁺
CaLa₂S₄:Ce³⁺
(Ba,Sr,Ca)MgP₂O₇:Eu²⁺,Mn²⁺
(Y,Lu)₂WO₆:Eu³⁺,Mo⁶⁺
(Ba,Sr,Ca)_{β}Si_{γ}N_{μ}:Eu²⁺ (wherein 2β+4γ=3μ)
Ca₃(SiO₄)Cl₂:Eu²⁺
(Y,Lu,Gd)_{2-φ},Ca_{φ}Si₄N_{6+φ}C_{1-φ}:Ce³⁺, (wherein 0≦φ≦0.5)
(Lu,Ca,Li,Mg,Y)alpha-SiAlON doped with Eu²⁺ and/or Ce³⁺
(Ca,Sr,Ba)SiO₂N₂:Eu²⁺,Ce³⁺
3.5MgO*0.5MgF₂*GeO₂:Mn⁴⁺
Ca_{1-c-f}Ce_{c}Eu_{f}Al_{1+c}Si_{1-c}N₃, (where 0<c≦0.2, 0<f≦0.2)
Ca₁₋ₕ₋ᵣCeₕEuᵣAl₁₋ₕ(Mg,Zn)ₕSiN₃, (where 0<h≦0.2, 0≦r≦0.2)
Ca₁₋₂ₛ₋ₜCeₛ(Li,Na)ₛEuₜAlSiN₃, (where 0≦s≦0.2, 023 f≦0.2, s+t>0)
Ca_{1-σ-χ-φ}Ceσ(Li,Na)_{χ}Eu_{χAl}_{1-σχ}Si_{1-σχ}N₃, (where 0≦σ≦0.2, 0<χ≦0.4, 0≦φ≦0.2)

For purposes of the present application, it should be understood that when a phosphor has two or more dopant ions (i.e. those ions following the colon in the above compositions), this is to mean that the phosphor has at least one (but not necessarily all) of those dopant ions within the material. That is, as understood by those skilled in the art, this type of notation means that the phosphor can include any or all of those specified ions as dopants in the formulation.

It will be appreciated by a person skilled in the art that other phosphor compositions with sufficiently similar emission spectra may be used instead of any of the preceding suitable examples, even though the chemical formulations of such substitutes may be significantly different from the aforementioned examples.

### Dynamic Color Devices

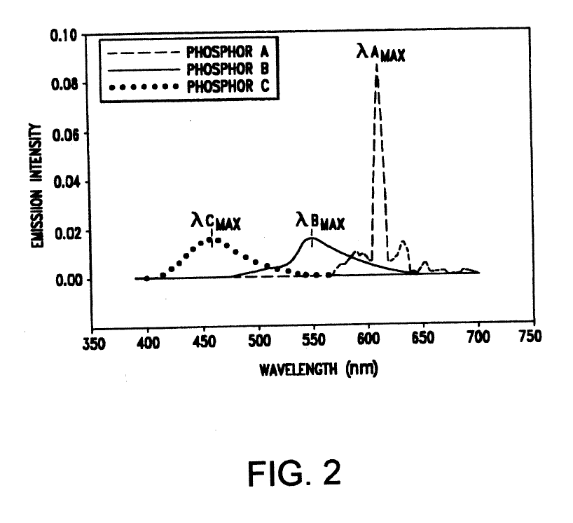

In one embodiment, each of the phosphor materials in each sub-array emits light preferentially at a different characteristic wavelength. By this it is meant that the peak emission for each of the phosphor materials corresponds to a different part of the electromagnetic spectrum, such that a different color is perceived by a viewer for each phosphor material. As shown in FIG. 2, for a light emitting device having three different sub-arrays (and thus three different phosphor materials A, B, and C), each phosphor material A, B, and C, has an emission spectrum with a maximum at a particular wavelength λₘₐₓ. While the emission spectra of the three phosphors may overlap, as shown in FIG. 2, the λₘₐₓ for each phosphor is preferably sufficiently separate from that of the other phosphor that the light emitted is perceived as different colors. For example the emission wavelength of phosphor A, λₘₐₓ, may be in the red part of the spectrum and the emission wavelength of phosphor B, λₘₐₓ, may be in the yellow part of the spectrum, and so on. The principle applies to any number of different phosphor materials. When each phosphor material is a different color, each phosphor material can be a single phosphor composition exhibiting that color or a blend of two or more phosphors, the combined emission of which emits the noted color. In addition to a device that can produce different colored light, the combination of emissions from two or more of the colored phosphor materials may be combined to form white light using light mixing optics in the device, as described above. By varying the power supplied to each sub-array, the relative emission intensity of each phosphor material can be varied.

### White Light Devices

In another embodiment, at least two phosphor materials each exhibit a white light emission such that, when excited by radiation from the LED, have an emission lying substantially on the blackbody locus, but possessing different color coordinates (for example x and y coordinates on the 1931 CIE chromaticity digram). Thus, each phosphor material has a substantially white light emission but having a different CCT value with the LED chip to be used (preferably but not necessarily in the near UV to violet range, e.g. 405 nm peak emission). In one embodiment, the two phosphor materials have CCT values that differ by at least 3500 K.

For example, one embodiment provides a device having two sub-arrays, with phosphor material A in sub-array 1 and phosphor material B in sub-array 2. The phosphor material A may produce white light having a color temperature T_{A} in the range 2000-4000K (corresponding to warm white light having enhanced red and yellow components), while the phosphor material B may produce white light having a color temperature T_{B} in the range 4000-10000K (corresponding to cool white light having enhanced green and blue components).

The number of phosphor compositions per phosphor material can be anywhere from 1 (such as the phosphors disclosed in U.S. Pat. No. 6,522,065) to 2, 3 or more (such as the phosphor blends disclosed in U.S. Pat. No. 6,685,852), the disclosures of which are incorporated herein in their entirety.

By independently varying the amount of power supplied to each of the two sub-arrays relative to each other in the lighting device, this allows one to alter the CCT of the device. That is, the two phosphor materials, having different color points, can be used to produce a lighting device having a CCT value at any point between the individual CCT values of the individual phosphor materials, depending on the amount of power supplied to each sub-array. The larger the difference between the CCT values of the individual phosphor materials, the larger the range of CCT values that the final device can have.

Thus, by selecting one phosphor that produces lower color temperature CCT_{A} and another phosphor that produces higher color temperature CCT_{B}, and by selecting their relative contributions appropriately, substantially any correlated color temperature between the lower color temperature CCT_{A} and the higher color temperature CCT_{B} can be achieved.

The relative contributions from each phosphor to the overall emission of the device can be varied from 0-100% by changing the amount of power supplied to the LED(s) in each sub-array. Advantageously, this enables the manufacturer to produce lighting sources with a color temperature variable anywhere within the range [CCT_{A}, CCT_{B}].

Thus, by varying the relative contribution from each phosphor material to the overall emission from the device, one can alter the final CCT of the device in a continuous fashion, while maintaining a consistent white output light on or near the blackbody locus.

In this way, the method disclosed herein allows one to tune the CCT of a lighting device without changing or affecting the chemical makeup of the phosphor compositions used therein or formulating new phosphor blends. This affords a set of at least two basic phosphor materials to be used for the manufacturing of white LEDs with customizable CCT values for specific applications.

As described above, each phosphor material can include one or more individual phosphor compositions. Preferably, the identity of the individual phosphor(s) in each material are selected such that the radiation emitted from each material, when combined with any residual emission from the LED chip, produces a white light.

The specific amounts of the individual phosphor compositions used in the phosphor materials will depend upon the desired color temperature for each phosphor material. The relative amounts of each phosphor in the phosphor materials can be described in terms of spectral weight. The spectral weight is the relative amount that each phosphor composition contributes to the overall emission spectrum of the phosphor material. Additionally, part of the LED light may be allowed to bleed through and contribute to the light spectrum of the device if necessary. The amount of LED bleed can be adjusted by changing the optical density of the phosphor layer, as routinely done for industrial blue chip based white LEDs. Alternatively, it may be adjusted by using a suitable filter or a pigment.

The spectral weight amounts of all the individual phosphors in each phosphor material should add up to 1 (i.e. 100%) of the emission spectrum of the individual phosphor material. Likewise, the spectral weight amounts of all of the phosphor materials and any residual bleed from the LED source should add up to 100% of the emission spectrum of the light emitting device.

In one white light device embodiment, the at least two different phosphor materials may comprise blends of the same phosphor compositions, albeit in different spectral weights. That is, the materials may comprise the same blend of phosphors in different proportions. Each of the phosphor materials will thus have different color coordinates due to the relative spectral weights of the individual phosphor compositions in the blends.

The ratio of each of the individual phosphor compositions in each of the phosphor materials may vary depending on the characteristics of the desired light output. As discussed above, the white light from each phosphor material preferably lies substantially on the blackbody locus, albeit with different CCT values. As stated, however, the exact identity and amounts of each phosphor compound in the phosphor material can be varied according to the needs of the end user.

It may be desirable to add pigments or filters to the phosphor materials. Thus, the phosphor materials and/or encapsulant may also comprise from 0 up to about 20% by weight (based on the total weight of the phosphors) of a pigment or other UV absorbent material capable of absorbing UV radiation having a wavelength between 250 nm and 500 nm.

Suitable pigments or filters include any of those known in the art that are capable of absorbing radiation generated between 250 nm and 500 nm. Such pigments include, for example, nickel titanate or praseodymium zirconate. The pigment is used in an amount effective to filter 10% to 100% of the radiation generated in the 250 nm to 450 nm range.

By assigning appropriate spectral weights for each phosphor composition, one can create spectral blends for use in each phosphor material to cover the relevant portions of color space, especially for white lamps. Thus, one can customize phosphor blends for use in the materials to produce almost any CCT or color point, with control over the CRI and luminosity based on the amount of each material in the lighting device.

By use of the present embodiments wherein two or more phosphor materials with different color points are used in a lighting device, devices can be provided having customizable color or, in the case of white light devices, customizable CCT. The preparation of each phosphor material, including the identity and amounts of each phosphor composition present therein, and the evaluation of its contribution to the LED spectrum would be trivial for a person skilled in the art and can be done using established techniques aided by, e.g., the DOE approach such as the preparation of a series of devices with various thicknesses of two phosphor materials.

The invention has been described with reference to the preferred embodiment. Obviously, modifications and alterations will occur to others upon reading and understanding the preceding, detailed description. It is intended that the invention be construed as including all such modifications and alterations insofar as they come within the scope of the appended claims or the equivalents thereof.

What is claimed is:

1. A light emitting device comprising at least first and second semiconductor radiation emitting components, which emit radiation having a first peak wavelength, a first phosphor material radiationally coupled with said first semiconductor radiation emitting component, the first phosphor material capable of absorbing at least a part of the radiation from the first radiation emitting component and emitting light of a second wavelength, and a second phosphor material radiationally coupled to said second semiconductor radiation emitting component, which is capable of absorbing at least a part of the radiation from the second radiation emitting component and emitting light of a third wavelength, such that when power supplied to at least one of the first and second semiconductor radiation components is varied, the color of light emitted by the light emitting device is changed.

2. The light emitting device of claim 1, wherein the first phosphor is at least substantially isolated from the second radiation emitting component and the second phosphor is at least substantially isolated from the first radiation emitting component.

3. The light emitting device of claim 1, wherein the first and second radiation emitting components are selected from the group consisting of light emitting diodes and laser diodes.

4. The light emitting device of claim 1, wherein at least one of said first and second radiation emitting components comprise a plurality of light emitting diodes.

5. The light emitting device of claim 1, wherein at least one of said first and second phosphor materials comprise two or more phosphor compositions.

6. The light emitting device of claim 1, further including: a controller for variably controlling power supplied to at least one of the first and second radiation emitting components separately from the other of the first and second radiation emitting components for varying the color of light emitted by the light emitting device.

7. The light emitting device of claim 6, wherein the power to both the first and the second radiation emitting components is separately variable.

8. The light emitting device of claim 6, wherein the controller includes a rheostat, which variably adjusts the power supplied to one of the first and second light emitting components.

9. The light source of claim 6, wherein the controller includes a control system which determines the amount of power to be supplied to the first and second light emitting components in accordance with a color of light selected by an operator.

10. The light emitting device of claim 1, wherein said first radiation emitting component and said first phosphor material comprise a first sub-array, and said second radiation emitting component and said second phosphor material comprise a second sub-array.

11. The light emitting device of claim 10, further comprising baffles between said first and second sub-arrays.

12. The light emitting device of claim 10, further comprising one or more additional sub-arrays, each additional sub-array comprising a radiation emitting component and a radiationally coupled phosphor material.

13. The light emitting device of claim 1, wherein said first and second phosphor materials are spaced apart from said first and second radiation emitting components such that a gap exists therebetween.

14. The light emitting device of claim 13, wherein said gap is filled with an encapsulant.

15. The light emitting device of claim 1, wherein said first and second phosphor materials are coated on a transparent substrate.

16. The light emitting device of claim 1, wherein said device comprises phosphor materials emitting red light, yellow light, blue light, and green light.

17. The light emitting device of claim 1, wherein said first and second phosphor materials comprise one or more phosphor compositions selected from the group including garnets activated with at least Ce³⁺, orthosilicates activated with at least Eu²⁺, sulfides activated with at least Eu²⁺, and nitrides, oxynitrides or sialons activated with at least Eu²⁺.

18. The light emitting device of claim 1, wherein said first and second phosphor materials comprise one or more phosphor compositions selected from the group including: (Ba,Sr,Ca)₅(PO₄)₃(Cl,F,Br,OH):Eu²⁺, Mn²⁺; (Ba,Sr,Ca)BPO₅:Eu²⁺, Mn²⁺; (Sr,Ca)₁₀(PO₄)₆*vB₂O₃:Eu²⁺ (wherein 0<v≦1); Sr₂Si₃O₈*2SrCl₂:Eu²⁺; (Ca,Sr,Ba)₃MgSi₂O₈:Eu²⁺, Mn²⁺; BaAl₈O₁₃:Eu²⁺; 2SrO*0.84P₂O₅*0.84P₂O₅*0.16B₂O₃:Eu²⁺; (Ba,Sr,Ca)MgAl₁₀O₁₇:Eu²⁺,Mn²⁺; (Ba,Sr,Ca)Al₂O₄:Eu²⁺; (Y,Gd,Lu,Sc,La)BO₃:Ce³⁺,Tb³⁺; ZnS:Cu⁺,Cl⁻; ZnS:Cu⁺,Al³⁺; ZnS;Ag⁺,Cl⁻; ZnS:Ag⁺,Al³⁺; (Ba,Sr,Ca)₂Si_{1-ξ}O_{4-2ξ}:Eu²⁺(wherein 0≦ξ≦0.2); (Ba,Sr,Ca)₂(Mg,Zn)Si₂O₇:Eu²⁺;(Sr,Ca,Ba)(Al,Ga,In)₂S₄:Eu²⁺; (Y,Gd,Tb,La,Sm,Pr,Lu)₃(Al,Ga)_{5-α}O_{12-3/2α}:Ce³⁺(wherein 0≦α≦0.5); (Ca,Sr)₈(Mg,Zn)(SiO₄)₄Cl₂:Eu²⁺,Mn²⁺; Na₂Gd₂B₂O₇:Ce³⁺,Tb³⁺; (Sr,Ca,Ba,Mg,Zn)₂P₂O₇:Eu²⁺,Mn²⁺; (Gd,Y,Lu,La)₂O₃:Eu³⁺,Bi³⁺; (Gd,Y,Lu,La)₂O₂S:Eu³⁺,Bi³⁺; (Gd,Y,Lu,La)VO₄:Eu³⁺,Bi³⁺; (Ca,Sr)S:Eu²⁺,Ce³⁺; SrY₂S₄:Eu²⁺; CaLa₂S₄:Ce³⁺; (Ba,Sr,Ca)MgP₂O₇:Eu²⁺, Mn²⁺; (Y,Lu)₂WO₆:Eu³⁺,Mo⁶⁺; (Ba,Sr,Ca)βSiγNμ:Eu²⁺ (wherein 2β+4γ=3μ); Ca₃(SiO₄)Cl₂:Eu²⁺; (Lu,Sc,Y,Tb)₂₋ᵤ₋ᵥ CeᵥCa₁₊ᵤLi_{w}Mg_{2-w}P_{w}(Si,Ge)_{3-w}O_{12-u/2} (where −0.5≦u≦1, 0<v≦0.1, and 0≦w≦0.2); (Y,Lu,Gd)_{2-φ}Ca_{φ}Si₄N_{6+φC}_{1-φ}:C³⁺, (wherein 0≦φ≦0.5); (Lu,Ca,Li,Mg,Y)alpha-SiAION doped with Eu²⁺ and/or Ce³⁺; (Ca,Sr,Ba)SiO₂N₂:Eu²⁺,Ce³⁺; 3.5MgO*0.5MgF₂*GeO₂:Mn⁴⁺;Ca_{1-c-f}Ce_{c}Eu_{f}Al_{1+c}Si_{1-c}N₃, (where 0<c≦0.2, 0≦f≦0.2); Ca₁₋ₕ₋ᵣCeₕEuᵣAl₁₋ₕ(Mg,Zn)ₕSiN₃,(where 0<h≦0.2, 0≦r≦0.2); Ca₁₋₂ₛ₋ₜCeₛ(Li,Na)ₛEuₜAlSin₃, (where 0≦s≦0.2, 0≦f≦0.2, s+t>0); and Ca_{1-σ-χ-φ}Ce_{σ}(Li,Na)_{χ}Eu_{φ}Al_{1+σ-χ}Si_{1-σ+χ}N₃, (where 0≦σ≦0.2, 0<χ≦0.4, 0≦φ≦0.2).

19. The light emitting device of claim 1, wherein said first and second semiconductor radiation emitting components emit radiation having a peak wavelength in the range of from about 370 to 410 nm.

20. A white light emitting device comprising at least first and second semiconductor radiation emitting components, which emit radiation having a first peak wavelength, a first white light emitting phosphor material radiationally coupled with said first semiconductor radiation emitting component, and a second white light emitting phosphor material radiationally coupled to said second semiconductor radiation emitting component, wherein the first and second phosphor materials have emissions with different x, y color coordinates on the 1931 CIE chromaticity diagram, taken either alone or with residual light bleed from the semiconductor radiation emitting components, such that when power supplied to at least one of the first and second semiconductor radiation components is varied, the CCT of white light emitted by the light emitting device is changed.

21. The light emitting device of claim 20, wherein the emissions from the first and second phosphor materials lie substantially on the black body locus.

22. The light emitting device of claim 20, wherein the first phosphor is at least substantially isolated from the second radiation emitting component and the second phosphor is at least substantially isolated from the first radiation emitting component.

23. The light emitting device of claim 20, wherein the first and second radiation emitting components are selected from the group consisting of light emitting diodes and laser diodes.

24. The light emitting device of claim 20, wherein at least one of said first and second radiation emitting components comprise a plurality of light emitting diodes.

25. The light emitting device of claim 20, wherein at least one of said first and second phosphor materials comprise two or more phosphor compositions.

26. The light emitting device of claim 20, further including: a controller for variably controlling power supplied to at least one of the first and second radiation emitting components separately from the other of the first and second radiation emitting components for varying the color of light emitted by the light emitting device.

27. The light emitting device of claim 26, wherein the power to both the first and the second radiation emitting components is separately variable.

28. The light emitting device of claim 26, wherein the controller includes a rheostat, which variably adjusts the power supplied to one of the first and second light emitting components.

29. The light source of claim 26, wherein the controller includes a control system which determines the amount of power to be supplied to the first and second light emitting components in accordance with a color of light selected by an operator.

30. The light emitting device of claim 1, wherein said first radiation emitting component and said first phosphor material comprise a first sub-array, and said second radiation emitting component and said second phosphor material comprise a second sub-array.

31. The light emitting device of claim 30, further comprising baffles between said first and second sub-arrays.

32. The light emitting device of claim 30, further comprising one or more additional sub-arrays, each additional sub-array comprising a radiation emitting component and a radiationally coupled phosphor material.

33. The light emitting device of claim 1, wherein said first and second phosphor materials are spaced apart from said first and second radiation emitting components such that a gap exists therebetween.

34. The light emitting device of claim 33, wherein said gap is filled with an encapsulant.

35. The light emitting device of claim 20, wherein said first and second phosphor materials are coated on a transparent substrate.

36. The light emitting device of claim 20, wherein at least one of said phosphor materials comprise red and blue emitting phosphor compositions.

37. The light emitting device of claim 20, wherein said first and second phosphor materials comprise one or more phosphor compositions selected from the group including garnets activated with at least Ce³⁺, orthosilicates activated with at least Eu²⁺, sulfides activated with at least Eu²⁺, and nitrides, oxynitrides or sialons activated with at least Eu²⁺.

38. The light emitting device of claim 20, wherein said first and second phosphor materials comprise one or more phosphor compositions selected from the group including: (Ba,Sr,Ca)₅(PO₄)₃(Cl,F,Br,OH):Eu²⁺,Mn²⁺; (Ba,Sr,Ca)BPO₅:Eu²⁺,Mn²⁺; (Sr,Ca)₁₀(PO₄)₆*vB₂O₃:Eu²⁺ (wherein 0<v≦1); Sr₂Si₃O₈*2SrCl₂:Eu²⁺; (Ca,Sr,Ba)₃MgSi₂O₈:Eu²⁺,Mn²⁺; BaAl₈O₁₃:Eu²⁺; 2SrO*0.84P₂O₅*0.16B₂O₃:Eu²⁺; (Ba,Sr,Ca)MgAl₁₀O₁₇:Eu²⁺,Mn²⁺; (Ba,Sr,Ca)Al₂O₄:Eu²⁺; (Y,Gd,Lu,Sc,La)BO₃₊,Tb³⁺; ZnS:Cu⁺,Cl⁻; ZnS:Cu⁺,Al³⁺; ZnS:Ag⁺,Al³⁺; (Ba,Sr,Ca)₂Si_{1-ξ}O_{4-2ξ}:Eu²⁺(wherein 0≦ξ≦0.2); (Ba,Sr, Ca)₂(Mg,Zn)Si₂O₇:Eu²⁺; (Sr,Ca,Ba)(Al,Ga,In)₂S₄:Eu²⁺; (Y,Gd,Tb,La,Sm,Pr,Lu)₃(Al,Ga)_{5-α}O_{12-3/2α:Ce}³⁺ (wherein 0≦α≦0.5); (Ca,Sr)₈(Mg,Zn)(SiO₄)₄Cl₂:Eu²⁺,Mn²⁺; Na₂Gd₂B₂O₇:Ce³⁺,Tb³⁺; (Sr,Ca,Ba,Mg,Zn)₂P₂O₇:Eu²⁺,Mn²⁺; (Gd,Y,Lu,La)₂O₃:Eu³⁺,Bi³⁺; (Gd,Y,Lu,La)₂O₂S:Eu³⁺,Bi³⁺; (Gd,Y,Lu,La)VO₄:Eu³⁺,Bi³⁺; (Ca,Sr)S:Eu²⁺,Ce³⁺; SrY₂S₄: Eu²⁺; CaLa₂S₄:Ce³⁺; (Ba,Sr,Ca)MgP₂O₇:Eu²⁺,Mn²⁺; (Y, Lu)₂WO₆:Eu³⁺,Mo⁶⁺; (Ba,Sr,Ca)_{β}Si_{γN}_{μ}:Eu²⁺ (wherein 2β+4γ=3μ); Ca₃(SiO₄)Cl₂:Eu²⁺; (Lu,Sc,Y,Tb)₂₋ᵤ₋ᵥCeᵥCa₁₊ᵤLi_{w}Mg_{2-w}P_{w}(Si,Ge)_{3-w}O_{12-u/2} (where −0.5≦u≦1, 0<v≦0.1, and 0≦w≦0.2); (Y,Lu,Gd)_{2-φ}Ca_{φ}Si₄N_{6+φ}C_{1-φ}:Ce³⁺, (wherein 0≦φ≦0.5); (Lu,Ca,Li,Mg,Y)alpha-SiAlON doped with Eu²⁺ and/or Ce³⁺; (Ca,Sr,Ba)SiO₂N₂:Eu²⁺,Ce³⁺; 3.5MgO*0.5MgF₂*GeO₂:Mn⁴⁺;Ca_{1-c-f}Ce_{c}Eu_{f}Al₁₊Si_{1-c}N₃,(where 0<c≦0.2, 0≦f≦0.2); Ca₁₋ₕ₋ᵣCeₕEuᵣAl₁₋ₕ(Mg,Zn)ₕSiN₃,(where 0<h≦0.2, 0≦r≦0.2); Ca₁₋₂ₛ₋ₜCeₛ(Li,Na)ₛEuₜAlSiN₃,(where 0≦s≦0.2, 0≦f≦0.2, s+t>0); and Ca_{1-σ-χ-φ}Ce_{σ}(Li,Na)_{χ}Eu_{φ}Al_{1+σ-χ}Si_{1-σ+χ}N₃, (where 0≦σ≦0.2, 0<χ≦0.4,0≦σ≦0.2).

39. The light emitting device of claim 20, wherein said first and second semiconductor radiation emitting components emit radiation having a peak wavelength in the range of from about 370 to 410 nm.

40. A method of changing the color of light emitted by a light emitting device, said method comprising:
providing first and second light emitting component which emits light of a first wavelength, a first phosphor material which absorbs at least a part of the light from the first light emitting component and emits light of a second wavelength, and a second phosphor material which absorbs at least a part of the light from the second light emitting component and emits light of a third wavelength;
adjusting power supplied to at least one of the first and second light emitting components separately from the other of the first and second light emitting components such that the amount of light emitted by at least one of the first and second phosphor materials is correspondingly adjusted; and
combining the light emitted by the first and second phosphor materials.
